(19) United States
(12) Patent Application Publication
(10) Pub. No.: US 2014/0250469 A1
(43) Pub. Date: Sep. 4, 2014

(54) MULTISERVICE SATELLITE COMMUNICATION APPARATUS FOR MEANS OF TRANSPORT

(71) Applicant: NAVISYSTEM MARINE ELECTRONICS S.R.L., Massarosa (lu) (IT)

(72) Inventor: Brunello Locatori, Camaiore (IT)

(21) Appl. No.: 14/348,740

(22) PCT Filed: Oct. 1, 2012
(86) PCT No.: PCT/IB2012/055262

§ 371 Date: Mar. 31, 2014

(30) Foreign Application Priority Data
Oct. 1, 2011 (IT) PI2011A000109

(51) Int. Cl. H04B 7/185; H04N 21/61; H04N 7/20

(52) U.S. Cl. CPC H04B 7/18595; H04N 7/20; H04N 21/6143
USPC 725/68

(57) ABSTRACT

An apparatus (200) for providing an access on a vehicle (10) to a first and to a second geostationary satellites, which are available through respective satellite signals that can be used by means of respective first and second peripheral devices (33a,33b), said apparatus (200) comprising: a first and a second directional orientable antennas (20a,20b) that are configured to receive said transmitted signals returning respective received signals (21a,21b); a first and a second distribution and/or collection systems (24a,24b) of said received signals (21a,21b), said first and said second distribution and/or collection systems (24a,24b) configured to transform a first and a second received signals (23a,23b) selected between said received signals (21a,21b) into respective distributed signals (32a,32b) intelligible respectively from said first and by said second peripheral device (33a,33b); a first and a second control unit (29a,29b) configured to receive respective first and second reference signals (27a,27b) selected between said first and said second received signal (23a,23b), respectively, and said first and second distributed signal (32a,32b), and arranged to form respective first and second control signals (28a,28b) associated with said first and with said second reference signals (27a,27b); a logical decision means (26) that are configured to receive said first and said second control signals (28a,28b) from said first and from said second control units (29a,29b), and are adapted to generate a switch signal (25) if at least one of said first and of said second quality parameter (28a,28b) does not match a predetermined admissibility condition; a switch unit (22) that is configured to receive said switch signal (25) and to operatively connect each of said first and of said second distribution and/or collection systems (24a,24b) with said first or with said second antennas (20a,20b) according to said switch signal (25).

### FIELD OF THE INVENTION

The present invention relates to an apparatus and to a method of multi-service satellite communication, i.e. to an apparatus and to a method for providing a vehicle, in particular a watercraft, with an access to a plurality of services that are available through geostationary satellites.

In particular, the invention relates to an apparatus for receiving TV transmissions and for using Internet services on board of watercrafts.

### BACKGROUND OF THE INVENTION

### Technical Problem

Apparatuses are known that comprise at least two satellite antennas to enable a permanent radio-TV reception/transception from geostationary satellites on vehicles such as watercrafts. Each antenna is normally arranged in one of the two longitudinal side halves of the watercraft, and at a same cross section of the watercraft. The signal collected by the antennas is received by a radio-TV set, or by a computer on board, through a signal distribution device, or through a receiver, which may be operatively connected to either antennas by a switch unit. If a shielding body interposes between a current antenna and a satellite of interest during a movement of the watercraft, the switch unit disconnects the current antenna and connects the other antenna of the apparatus, to prevent a communication breakdown. The shielding body could be a structure of the watercraft, for example the shaft, or it could be an external shielding body, for instance a harbour structure. The switch unit may be operated by a level or quality parameter of the signal received by the antenna in use, and may trigger the switch unit when the level or the quality lowers below a predetermined threshold.

An apparatus of this type can ensure a substantial connection stability with only one satellite at a time, and can therefore ensure a substantial continuity of one prefixed service, for example the TV reception. In other words, a couple of antennas that can be selectively connected with a reception system can ensure a substantial continuity of only one service, and an additional number of antennas would be required that it is twice the number of the receivable satellites or of the available services in order to ensure a substantial continuity for all of them.

On vehicles such as watercrafts, a need is also felt of further services, in particular of data communication services, typically an Internet signal, as well as of voice communication services such as a satellite telephone service, wireless services such as a weather forecast service, civil and military reserved data channels and the like. As a rule, Internet services can be received from satellites that are at different satellite positions and/or they can be received on frequency bands that are different from the positions and the bands of radio-TV communications.

To this purpose, single-service systems have been developed, such as “V-sat”, for data exchange and “mini-M” for satellite telephones. In order to allow a communication that is stable even in the presence of shielding bodies, a number of pairs of antennas would be required which is the same number as the services that are provided. In most common cases, the watercraft is provided with a TV service and with an Internet service; a couple of antennas is present for TV reception, and a couple of antennas is present for accessing to Internet.

In order to provide a vehicle with a plurality of services, considerable costs must be faced, and since the antenna dishes require large installation spaces large areas should be dedicated to antennas on board of the watercrafts.

Moreover, when any of the available services is used, an antenna of each couple of antennas that is dedicated to this service is not used.

US 2010/0135198 A1 describes a satellite transmission/reception apparatus and a method for controlling a communication route that uses the apparatus. The satellite transmission/reception apparatus comprises a first antenna unit that is configured to receive a signal travelling along a first communication route, a second antenna unit that is configured to receive a signal travelling along a second communication route, and a data processor that is configured to compare cyclical redundancy check (CRC) values with respect to packet streams of signals received by the first and by the second antenna unit, respectively, and that is configured to change the communication route in use to a communication route selected between the first and the second communication routes if packets are detected that have the same CRC value. In particular, the first antenna unit may directly receive a signal transmitted by a satellite, and the second antenna unit may receive a transmitted signal by a satellite through a repeater.

FR 2 793 631 describes a multimedia bidirectional communication terminal comprising at least two orientable antennas for transmitting/receiving radiofrequency signals that carry multimedia data, an electronic means for treating the received signals or signal that must be transmitted through the antennas, a means associated with each antenna for orienting it towards a satellite of towards a group of satellites at the same satellite position that belong to a multimedia telecommunications system, and a means for selectively switching the transmission of multimedia data between the terminal and the satellites of the group, from the satellite toward which one of the antennas is oriented to the satellite towards which the other antenna is oriented, in order to ensure the continuity of the data stream transmitted between the terminal and the satellite group.

### SUMMARY OF THE INVENTION

It is therefore a feature of the present invention to provide a satellite communication apparatus for a vehicle, in particular for a watercraft, which makes it possible to reduce the number of the antennas required to use a same number of available services, thus reducing the cost of the apparatus and its installation and limit the areas dedicated to the antennas.

It is also a feature of the invention to provide a method and an apparatus that allows using the antennas more intensively.

It is also a feature of the present invention to provide a method and an apparatus that allows communicating with geostationary satellites that have features different from one other, in terms of used frequency bands, operating signal polarization, and the like.

These and other objects are achieved by a satellite communication apparatus for a vehicle as defined by attached claim 1. Advantageous exemplary embodiments of the apparatus are defined by dependent claims 2 to 6. The above objects are also achieved by a method of satellite communication for a vehicle as defined by attached claim 7. Advantageous exemplary embodiments of the method are defined by dependent claims 8 to 10.

According to the invention, a multi-service apparatus is provided for providing an access, on a vehicle such as a watercraft, to at least a first and a second communication services that are available from a respective geostationary satellite. In particular, the first service may be a reception service, for example a TV reception service, and the second service may be a reception and transmission service between the apparatus and a given satellite, normally selected among a plurality of enabled satellites, for example it may be an Internet or a VoIP service, or a satellite telephone service. The apparatus comprises systems for distributing and/or collecting different signals for the first service and for the second service, and can control or possibly comprises two orientable directional antennas. The TV reception distribution systems may comprise modules such as personal receivers that are associated with respective radio-TV sets, whereas the Internet distribution and collection systems may comprise modules comprising suitable modem devices that are associated with personal computers or with VoIP devices. The apparatus advantageously comprises respective control units, i.e. units for evaluating the signals received by the two antennas, which are configured to change such pointing parameters as the azimuth, elevation and skew angles with respect to the watercraft, in order to tracking a predetermined satellite, i.e. to keep a predetermined satellite position pointed when the vehicle is moved or travels, in a known way. The main feature of the apparatus, according to the invention, is that it comprises:

a logical decision unit, for example a CPU, which is configured to receive control signals pertaining to the signals received by the antennas, for example signals that comprise quality parameters such as an intensity of the signals as they are received by a single antenna or as they are processed by the distribution and/or collection unit, as well as signals comprising a “lock” or a “non-lock” condition of each antenna with respect to a prefixed satellite. The logical decision unit is also adapted to generate a switch signal if at least one of the above signals, pertaining to one of the communication services that are provided, is not good enough for supporting an acceptable quality level of the service;

a switch means configured to receive this switch signal and to swap the connection between at least one of the distribution and/or collection systems from a previously operatively connected antenna and the other antenna or another antenna, different from the previously operatively connected antenna.

In a basic automatic operation mode, the antenna-switch, i.e. the antenna-swap is carried out until both first and the second service are restored, if this is possible. This way, in most cases a substantial continuity of the first and of the second communication service can be obtained by means of one couple of antennas, whereas two couples must provided with the prior art one-service devices.

In a simple-priority operation mode, the antenna-swap is carried out until a single prefixed service, set as the priority service, is restored, and a possibility is left for the other service to be available. With respect to the basic automatic mode, this makes even less likely a breakdown of the available services that is considered as the most important, which is therefore defined as the priority service by the user.

In a double-priority operation mode, each signal distribution and/or collection system is connected to one of the two antennas and both antennas are oriented towards a same satellite that provides this service. The operation of the signal evaluation unit and of the switch means is similar to what was described above, and the antennas always keep pointed towards a satellite position where the satellite is available with the service that is defined as the double-priority service by the user. This way, the availability of the service is permanently ensured. Furthermore, even short interruptions are excluded which would otherwise depend upon the time required for pointing the antenna that is in turn operatively connected to the distribution and/or collection unit.

This way, the twin apparatus configured to receive television services and for receiving Internet services can ensure all the following operation modes:
a) use of a TV service and of an Internet service, which are normally provided by two respective prefixed satellites;
   a1) with a simple automatic swap;
   a2) with a manual swap;
   a3) with a priority swap, in which case the swap is carried out only if the priority service cannot be received any longer by the antenna in use, which is pointed towards the respective satellite;
b) TV double priority, in which a selected TV service is always provided by both antennas, which are both always pointed towards a predetermined satellite, and is in real-time electronically swapped from one antenna to another antenna, if the selected service cannot be received any longer by the antenna in use. The fully electronic swap avoids that the TV connectivity is lost for even one second;
c) Internet double priority, where an Internet service, including VOIP, streaming, IPTV, videoconference, is always provided by both antennas, which are both always pointed towards a predetermined satellite, and is in real-time electronically swapped from one antenna to another antenna, if the selected service cannot be received any longer by the antenna in use. The fully electronic swap avoids that the web connectivity is lost for even one second;
d) contemporaneous connectivity with two different satellites providing television services, for example 101° W and 119° W;
e) contemporaneous connectivity with two different satellites providing an Internet service, in which a bandwidth portion, for example 50%, is provided by first satellite and the other bandwidth portion is provided by a second satellite;
f) a FCC operation mode, which is a US typical mode of operation but is spreading also in the rest of the world, according to which the antennas are not allowed to irradiate towards the inside of a watercraft. The antennas of a twin system may be arranged on two sides of the watercraft and may be programmed for transmitting outwards the watercraft, at opposite sides, for example within a transmission angle of about 200° for each antenna. A third antenna is combined to the twin system, and serves for covering, if this is required, the angle that is left uncovered, in order to provide the service, or to provide a further service if there are no uncovered angles.
g) it is also possible to combine a plurality of automatic, manual and priority multiple-swap systems including more than two antennas.

Moreover, the ratio between the services in use and the number of antennas is higher than what is known from the available prior art. For instance, in order to solve the problem of the shielding bodies and of the obstacles that may interpose between an antenna and a prefixed satellite, two antennas are required for each service, for example two antennas for receiving a service available from a given satellite, two antennas for Internet service and so on. The couples of antennas typically comprise antennas that are arranged at opposite sides with respect to the mid-line of a watercraft.

On the contrary, in the twin system according to the invention, Internet and TV are available by means of two antennas that, due to the swap logic, can ensure the same service that is ensured by means of four antennas of a conventional apparatus.

### BRIEF DESCRIPTION OF THE DRAWINGS

The invention will now be shown with the description of exemplary embodiments of the apparatus and of the method according to the invention, exemplifying but not limitative, with reference to the attached drawings, in which equal reference characters designate the same parts or similar parts, throughout the figures of which:

FIG. 1 diagrammatically shows a condition in which a satellite is obscured to an antenna of a watercraft;

FIG. 2 is a simplified diagram view of a satellite communication apparatus according to an exemplary embodiment of the invention, comprising two antennas;

FIG. 3 is a block diagram that describes a basic automatic operation mode of the apparatus of FIG. 2;

FIG. 4 is a block diagram that describes an automatic operation mode where a priority status is set for one of the satellites, i.e. for a service that is provided by that satellite;

FIG. 5 is a block diagram that describes an automatic operation mode of the apparatus of FIG. 2, where a double priority status is set for one of the available services, which can be selected by the user;

FIG. 6 is a block diagram that describes a manual operation mode of the apparatus of FIG. 2;

FIG. 7 is a simplified diagram of a satellite communication apparatus according to another exemplary embodiment of the invention;

FIG. 8 shows an operation mode of the apparatus that is diagrammatically shown in FIG. 7;

FIG. 9 shows an apparatus according to a further exemplary embodiment of the invention, in which a third receiving antenna is also present;

FIG. 10 shows an arrangement of the antennas of the apparatus of FIG. 9 on a watercraft;

FIG. 11 shows an apparatus that comprises four satellite antennas;

FIGS. 12 and 13 diagrammatically show a feeder i.e. a feedhorn which is advantageously a part of the antenna of a device according to the invention.

### DESCRIPTION OF PREFERRED EXEMPLARY EMBODIMENTS

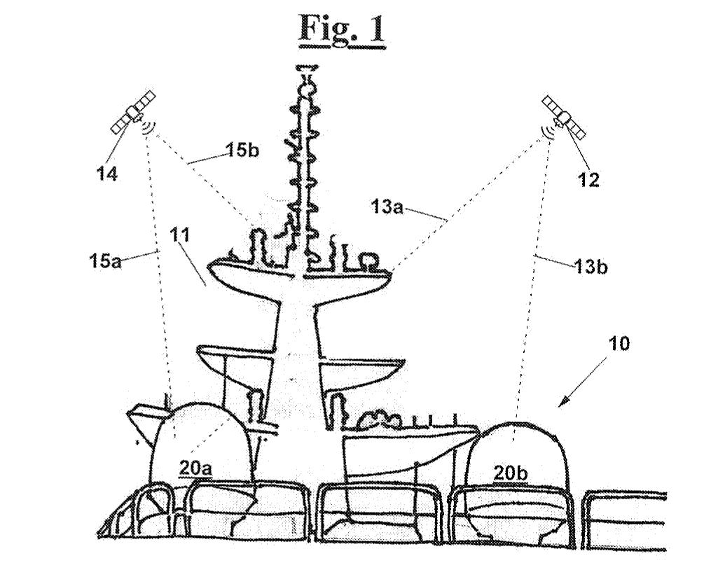

With reference to FIG. 1, the top portion of a satellite installation or apparatus is diagrammatically shown on board of a watercraft 10, whose top portion is outlined. The satellite apparatus comprises a first antenna 20a and a second antenna 20b, which are arranged at opposite sides with respect to a longitudinal symmetry plane of the watercraft, not shown, and are usually arranged at a same cross section of the watercraft. Two satellite positions 12 and 14 are also diagrammatically shown, which correspond to respective geostationary satellites, each of which provides a service of interest such as a plurality of radio-TV programmes, or an Internet service, or a satellite telephone service, or a weather forecast service, or a civil reserved data channel such as a corporate data channel, or a military reserved data channel. Lines 13a and 13b indicate respective pointing directions of orientable directional antennas 20a,20b towards satellite position 12, whereas lines 15a and 15b indicate respective pointing directions of orientable directional antennas 20a,20b towards satellite position 14.

In the situation of FIG. 1, satellite position 12 is obscured with respect to antenna 20a by structure 11 of watercraft 10, whereas satellite position 12 can be seen from antenna 20b. On the contrary, satellite position 14 is obscured with respect to antenna 20a by structure 11 of watercraft 10 and satellite position 14 can be seen from antenna 20b. A similar situation may occur when satellite position 12 is obscured, with respect to one of two antennas 20a,20b, by a natural or artificial shielding body out of watercraft 10, for example by a harbour structure or by another structure, or by a mountainous and rocky coastline. The expression “obscured” relates to the presence of a shielding body located between antenna 20a,20b and satellite position of interest 12 along respective pointing directions 13a,13b, which is large enough to impede the reception of a satellite 12,14 by one of antennas 20a,20b.

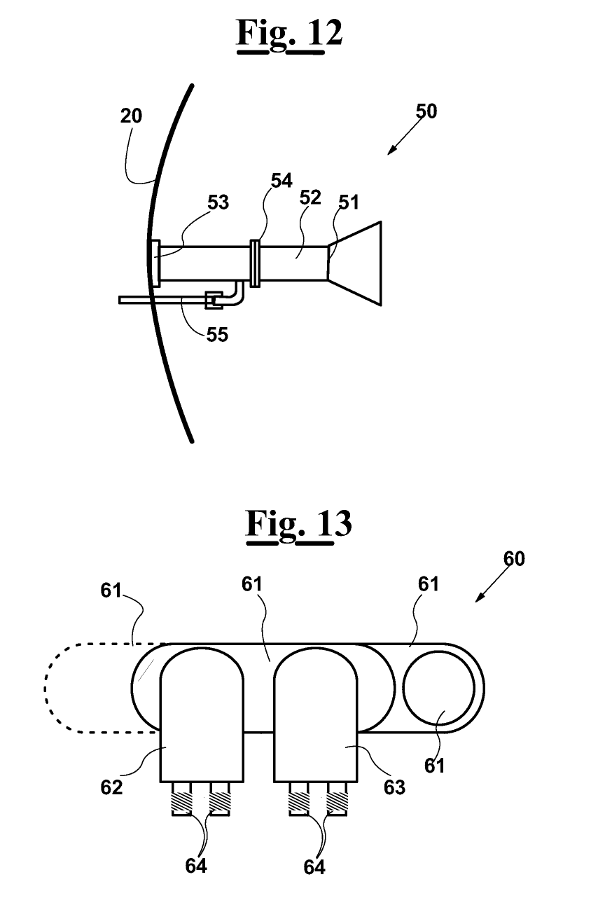

Advantageously, antennas 20a/b comprise a feedhorn or feeder of the type shown in FIGS. 12 and 13, as it is described hereinafter.

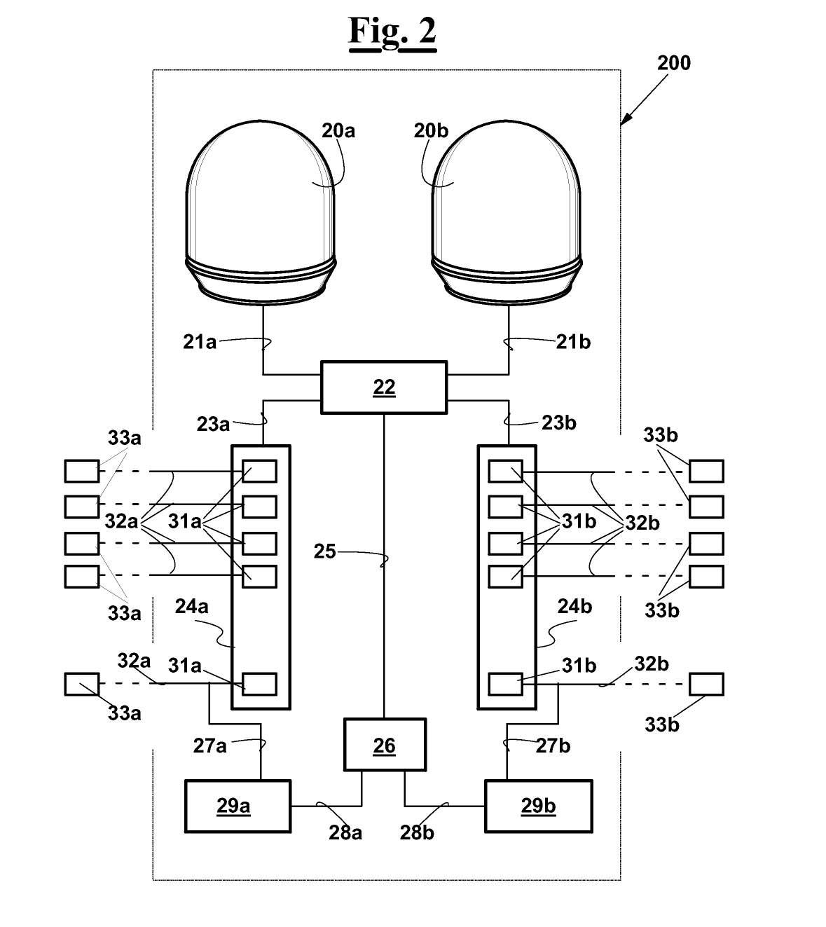

FIG. 2 diagrammatically shows a satellite communication apparatus 200 for a vehicle, for example for a watercraft, according to an exemplary embodiment of the invention. Apparatus 200 comprises two orientable directional antennas 20a,20b, diagrammatically shown in an operation arrangement comprising a protection radome. The antennas may have a feeder or feedhorn that is configured to receive and to emit signals of frequency comprised in any of the bands that are used in satellite communications, for instance the L-band, the C-band, the X-band, the Ku-band, the Ka-band, and so on. In the exemplary embodiment of FIG. 2, two antennas 20a,20b are “twin antennas”, i.e. they are identical and each of them can do the same work as the other. In a possible application, they may be arranged on a watercraft 10, as described with reference to FIG. 1.

For example, these reception and emission or “transception” devices may have the features disclosed by WO 2005/067099.

Apparatus 200 also comprises two multiple-swap devices, i.e. two distribution and/or collection systems 24a and 24b for the signals received by antennas 20a,20b. In particular, two distribution and/or collection systems 24a,24b are adapted to distribute the signals that come from antenna 20a or from antenna 20b to user-devices 33a,33b that provide the services to respective users. For instance, and not limitedly, a user-device 33a,33b may be a TV-set, a computer, a tablet, a telephone device, a router device, a TV decoder, or the like.

In the simplified representation of FIG. 2, connection means 21a/b,23a/b,32a/b of apparatus 200 are provided that comprise received or RX signals connection means, and transmission or TX signals connection means.

Each distribution and/or collection system 24a,24b may be a homogeneous distribution system, i.e. one that is configured to distribute signals of a same service, for example an Internet or a television service, or may be a multi-purpose distribution system, in other words each collection and/or distribution system 24a,24b may comprise distribution modules that are adapted to distribute mixed services, for example Internet or TV services.

The expression “mixed services” relates to services that cannot be provided to peripheral devices 33a,33b by means of distribution and/or decoder devices of the same type.

Apparatus 200 of FIG. 2 comprises homogeneous distribution and/or collection systems 24a,24b. For example, system 24a may be a distribution system for a radio-TV signal received by antenna 20a or by antenna 20b. Distribution system 24a comprises a plurality of distribution modules 31a for distributing the radio-TV signal to respective user-devices 33a, which are typically decoder devices or satellite receivers dedicated to, or integrated in, single radio-TV sets. On the contrary, system 24b may be an input Internet data distribution system or an output Internet data collection system, which comprises at least one modem device and respective connectors or data distribution and collection modules 31b for distributing input data to antennas 20a,20b and for receiving output data coming from peripheral devices 33b. Distribution and collection system 24b is therefore configured to return an intelligible and reproducible signal, starting from an input signal to antenna 20a,20b, for instance, by a VoIP device, or a computer or a similar device, and to transform an output data stream into a signal that can be wireless transmitted by means of antennas 20a,20b;

FIG. 2 may also refer to an apparatus comprising distribution and/or collection systems for homogeneous services. For example, both distribution and/or collection systems 24a,24b may be radio-TV signals distribution systems.

Device 200 of FIG. 2 also comprises, for each distribution and/or collection system 24a,24b, a respective control unit 29a and 29b. Distribution and/or collection systems 24a,24b have an output means 27a,27b through which the same user signals 32a,32b are provided also to a control unit 29a and 29b, respectively. This output means may be derived from distribution modules 31a and 31b.

In an exemplary embodiment, control unit 29a,29b is configured to check, in a known way, a lock condition of a respective antenna 20a or 20b with a given satellite 12 or 14, and to keep each antenna 20a,20b pointed towards a given satellite, in order to keep the lock condition and so to ensure that the services are continuously provided when the vehicle 10 is moved or is travelling.

As well known, a lock condition between a satellite antenna and a given satellite means a condition in which the antenna steadily receives signals from this satellite. In an installation on a vehicle, this lock condition comprises a condition of tracking this satellite by the satellite antenna. In other words, the orientation of the antenna with respect to the vehicles is dynamically changed to keep the antenna pointed towards this satellite, in order to ensure the continuity of the reception.

The lock condition provides that the satellite is recognized by a recognition means associated with the antenna, which may belong to control unit 29a/29b. The recognition means may operate with a conventional technique of comparing a group of reception parameters of a signal currently received from the satellite, for example a group of parameters comprising the frequency, the symbol rate, the FEC, the polarization, with a group of corresponding parameters, pertaining a transponder of the given satellite that must be tracked. Alternatively, the recognition means may operate by a conventional technique of comparing a recognition signal, i.e. a NIT, which is currently received from the satellite, and a known recognition signal of a predetermined satellite that must be tracked, in case this is provided by the satellite.

In an exemplary embodiment, control unit 29a,29b is configured to perform an evaluation of the quality of respective predefined received signals 23a and 23b and to produce an intensity and/or quality parameter of the signal received and/or returned by distribution and/or collection systems 24a and 24b, respectively, and to return an acceptability signal.

Signal evaluation unit 29a,29b is configured to emit respective control signals for adapting the pointing parameters of antennas 20a,20b to mobile means 10, in order to ensure the continuity of the services when vehicle 10 is moved or is travelling.

Control units 29a,29b comprise a connection means 28a,28b for connecting a CPU 26. CPU 26, according to an aspect of the invention, comprises a logical means configured to decide which of two antennas 20a,20b, in a given situation, must be used to receive signals from satellite 12 and which must be used to receive signals from satellite 14. To this purpose, CPU 26 is configured to generate an antenna-swap drive signal, and has a connection means 25 for connecting a switch unit 22. Switch unit 22 is configured to receive the antenna-swap drive signal and to operatively connect distribution and/or collection systems 24a, and therefore control unit 29a, with one of antennas 20a and/or 20b.

The expression “connection means” refers to a means of known type for transferring, depending on the circumstances, radiofrequency signals, data signals, control or drive signals, and may be a wired means, a wireless means such as a channel of suitable radiofrequency, or another well known means.

FIG. 2 may be described also as a block diagram of a method operated by apparatus 200, where each element 22,24a,24b,26,29a,29b relates to a step of the method that is carried out by the respective components of the same reference number.

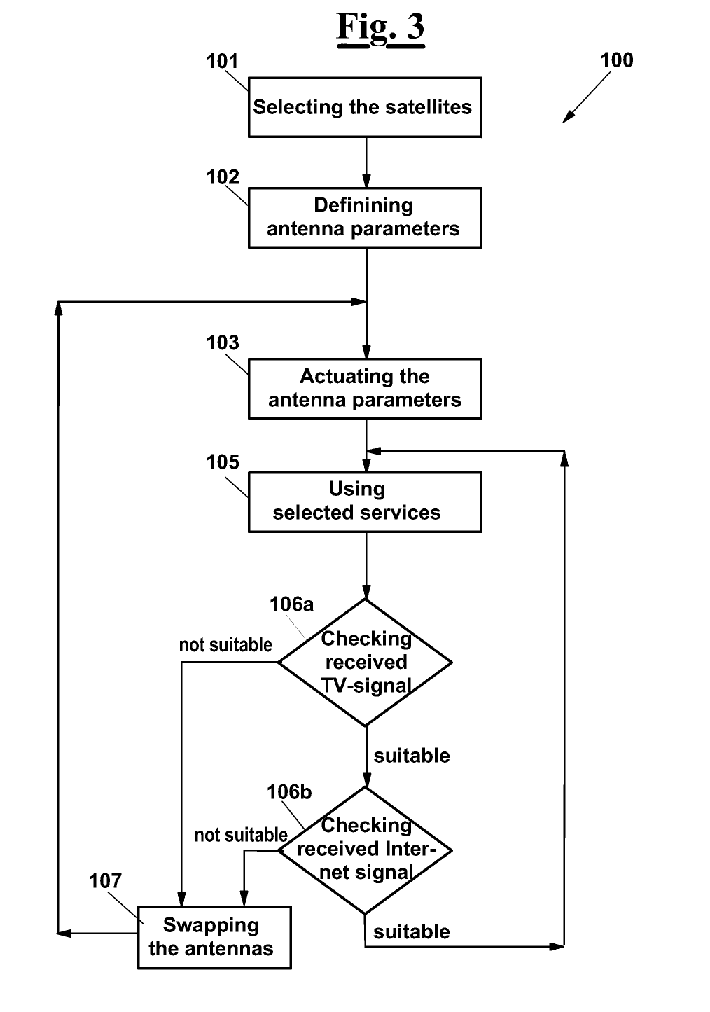

FIG. 3 shows a block diagram of a basic automatic operation mode 100 of apparatus 200, configured as a “twin” system, i.e. comprising two twin antennas. This operation mode comprises a step 101 of selecting a first satellite, for example a satellite that provides a radio-TV service, and a second satellite, which provides another service, for example an Internet service or a different radio-TV service.

After satellite selection step 101, a step 102 is carried out of defining antenna parameters for receiving the two satellites selected among a group of predefined satellites, typically among 12 satellites, such as the reception band, the transmission polarization at a specific frequency, and other parameters known to a person skilled in the field of satellite communication.

Afterwards, a step 103 is carried out of actuating the antenna parameters, comprising a step of pointing each antenna 24a and 24b towards the respective satellite. Step 103 of actuating the antenna parameters may also comprise a step of selecting a LNB (FIG. 12), according to the reception band selected in step 102 of defining the antenna parameters. Step 103 of actuating the antenna parameters may also comprise a step of mechanically rotating the feeder for tuning the polarization of the feeder with the polarization with which a satellite that is located at the selected satellite position emits/receives the signals of the data service.

After step 102 of defining the antenna parameters, a step is also carried out of associating each distribution and/or collection system 24a,24b, and therefore each control unit 29a,29b (FIG. 2) with an antenna selected between antenna 20a and antenna 20b. This association step is actuated by operating switch unit 22. This association step may comprise a step of restoring a predetermined initial position of switch unit 22, according to which, for instance, antenna 20a is used to receive signals from satellite 12, and antenna 20b is used to receive signals from satellite 14. The association step may comprise a step of returning to a previous position of switch unit 22, i.e. a position that switch unit 22 had in a previous radio-TV session and/or Internet session by apparatus 200.

For example, radio-TV distribution and/or collection system 24a may be operatively connected to antenna 20a, whereas Internet distribution and collection system 24b may be connected to antenna 20b. Alternatively, radio-TV distribution system 24a may be operatively connected to antenna 20b, whereas Internet distribution and collection system 24b may be connected to antenna 20a.

This way, a step 105 is enabled of using the services supplied by satellites 12,14, in the above example a step of receiving step radio-TV programmes and a step of performing an Internet session.

During step 105 of using the services or communication step, i.e. during normal operation of apparatus 200, steps may be periodically performed of analysing the signals, comprising a step 106a of checking the level and/or the quality of the radio-TV signal, and a step 106b of checking the level and/or the quality of the Internet signal, i.e. respectively, a check of the suitability of the signals received through antennas 20a,20b to support an acceptable quality level of the service. Signal level check steps 106a and 106b are carried out by control unit 29a,29b. As shown in the diagram of FIG. 3, if at least one of this check steps 106a,106b indicates that the respective signal is not suitable for using the corresponding service, for example if this signal is at a minimum value or it is missing due to an obscuration of respective satellite position 12 to an antenna 20a,20b, respective control unit 29a and/or 29b sends a low level signal or a low quality signal 28a and/or 28b to CPU 26. In this case, a step 107 is carried out of swapping the antennas, i.e. if antenna 20a was initially operatively connected to radio-TV distribution system 24a and antenna 20b was initially operatively connected to Internet distribution and collection system 24b, antenna 20a is now operatively connected to distribution and collection system 24b and antenna 20b is now operatively connected to distribution system 24a, or vice-versa.

After antenna-swap step 107, step 103 of actuating the antenna parameters must normally be carried out again, comprising a step of pointing antennas 20a,20b, since satellites 12 and 14 predefined for each control unit 29a,29b are normally different satellites or in any case they are located at different satellite positions.

Antenna-swap step 107 is discontinued only if both check steps 106a and 106b show a lock condition or an acceptable signal level. However, a logical stop means, not shown in FIG. 3, may be provided for swap step 107, by which swap step 107 is discontinued regardless the result of check steps 106a and 106b after a predetermined time, or according to an operator's instruction. In fact, it may happen that the nature of the shielding body that causes the obscuration of the satellite position(s), and the distance of the satellite positions from each other is such that both services cannot be restored at the same time.

Obviously, if none of check steps 106a and 106b indicates a low level or a low quality condition of the received signal, nor a no-signal condition occurs, communication step 105 continues and the previous bidirectional association is maintained, as defined by the current position of switch unit 22, between distribution and/or collection devices 24a,24b, on the one hand, and antennas 20a,20b, on the other hand, and providing that check steps 106a and 106b are periodically carried out.

The precedence order with which check steps 106a and 106b are performed, as indicated in FIG. 3, is given just as an example.

Practically, in basic automatic operation mode 100, the association between distribution system 24a,24b and antenna 20a,20b is kept unchanged until both signals are strong enough to allow using the respective services, and this association is changed only if at least one of the two signals is insufficient or missing, until a condition for using both services is restored or, if it is the case, until a predetermined time has elapsed after the first swap, or until an operator manually discontinues the swap sequence 107.

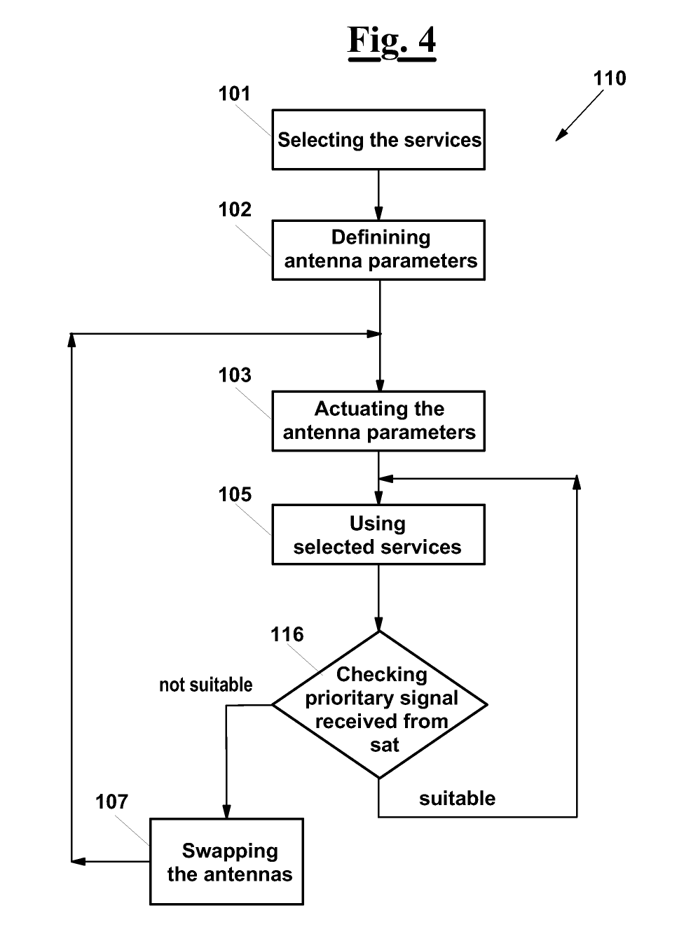

The block diagram of FIG. 4 diagrammatically shows an automatic operation mode 110 of device 200 of FIG. 2, in which priority is given to one of the services, for example priority is given to the radio-TV service. This service is hereinafter defined the priority service.

This operation mode is described by a first sequence of steps 101-105 that are the same steps as in the basic automatic operation mode 100. Step 105 of using the services is carried out along with a periodic check 116 of the signal level or of the lock condition, which is carried out by only one of the distribution and/or collection systems 24a,24b. For instance, only the signal treated by radio-TV distribution system 24a may be checked, in which case the operation mode is a radio-TV-priority automatic operation mode, or only the signal treated by Internet distribution and collection system 24b may be checked, in which case the operation mode is an Internet-priority automatic operation mode.

As shown in the diagram of FIG. 4, if check step 116 indicates that a tracking condition, i.e. a lock condition is missing, or indicates that the signal is not suitable for using the priority service, respective control unit 29a and/or 29b sends a low-level signal or a low-quality signal 28a and/or 28b to CPU 26. Even in this case, antenna-swap step 107 is carried out, as described above.

With respect to the basic automatic operation mode, the result of the sequence of antenna-swap steps 107 is configured to use only the priority service. This result is secured in part by that, if a satellite position 12 is obscured for an antenna, for example antenna 20a, it should not be the same for the other antenna 20b, as in the case of prior art systems. Moreover, it may happen that a same service, typically an Internet service, is provided by a plurality of geostationary satellites at different satellite positions, at least two of which can be reached from the coordinates geographic where the vehicle is located.

Even in this case, after antenna-swap step 107, step 103 of actuating the antenna parameters may be normally carried out again, comprising a step of pointing antennas 20a,20b. This antenna-pointing step, and then step 103 of actuating the antenna parameters, may require a time that depends upon the angular distance between the initial satellite position and the target satellite position, and which may even be a few seconds if the two initial and target satellite positions are particularly far from each other.

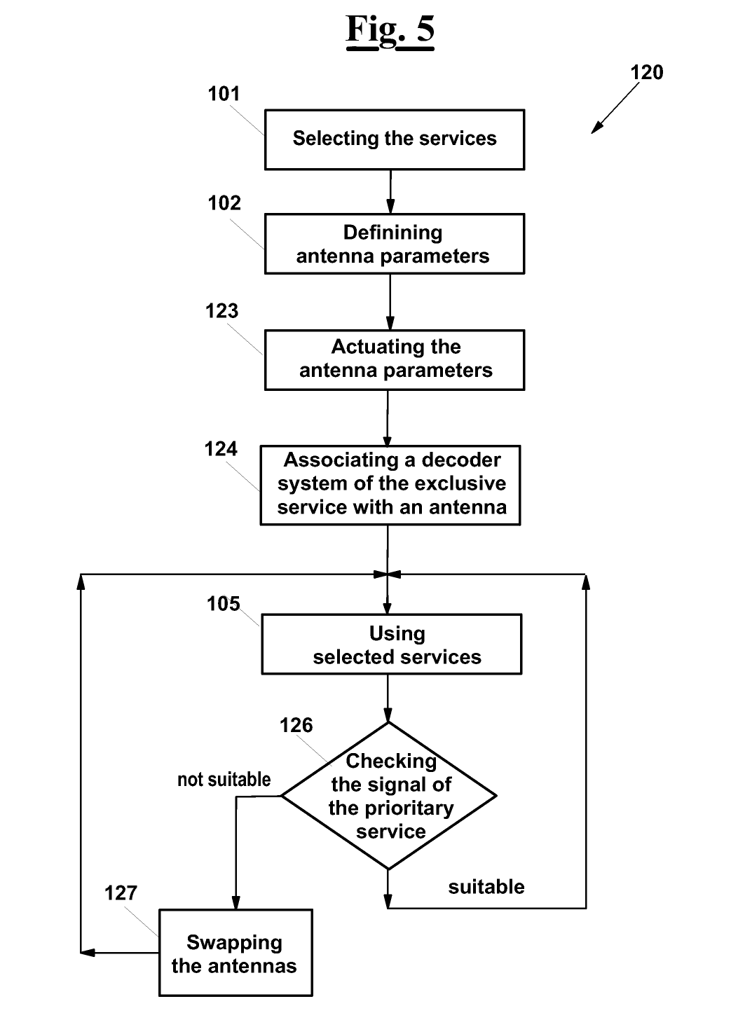

FIG. 5 shows a flow diagram of a double-priority automatic operation mode 120 of apparatus 200 of FIG. 2. This operation mode differs from simple-priority automatic operation mode 110 in that step 123 of actuating the antenna parameters comprises setting for both antennas 20a,20b the parameters to receive a single double-priority service, i.e. the service to which double priority is allowed. Step 123 of actuating the antenna parameters comprises a step of pointing both antennas 20a,20b towards a same satellite position that corresponds to a geostationary satellite by which the double-priority service is provided, or towards two satellite positions in which respective satellites are located by which the same service is provided. Step 123 of actuating the antenna parameters may also comprise a step of actuating a feedhorn configured to use a frequency of a band in which the double-priority service is provided by the geostationary satellite. Moreover, double-priority operation mode 120 differs from simple-priority operation mode 110 in that a step 124 is provided of associating only one distribution and/or collection systems 24a,24b with an antenna selected between antenna 20a and antenna 20b, corresponding to the double-priority service, instead of step 104 of associating each distribution and/or collection system 24a,24b with a single antenna.

For example, the double-priority service may be the radio-TV reception service, or the Internet service

Therefore, in double-priority automatic operation mode 120 only the use of the double-priority service is ensured, while the use of the other service, which is not the double-priority service, is excluded.

Communication step 105 is carried out providing a periodic check 126 of the signal level computed only by the enabled distribution and/or collection system 24a,24b that corresponds to the double-priority service.

As shown in the diagram of FIG. 5, if check step 126 indicates that a lock condition is missing or indicates that the signal is not suitable for using the double-priority service, control unit 29a, in the case of double radio-TV priority, or control unit 29b, in case of double Internet priority, sends a low-level signal or a low-quality signal 28a,28b to CPU 26. Even in this case, a step 127 is carried out of swapping the antennas, which are always both pointed towards a given satellite, therefore the step of swapping antennas 20a,20b with respect to distribution units 24a,24b comprises exclusively a fully electronic swap step, without changing of the mechanical pointing parameters.

Therefore, double-priority operation mode 120 differs from simple-priority operation mode 110 also in that, after antenna-swap step 127, step 103 of actuating the antenna parameters needs not be carried out any longer, therefore the antenna to be operatively connected is already ready for receiving signals from the predetermined satellite position, possibly with the right feeder already ready to operate. For this reason, antenna-swap step 127 is not associated with any significant waiting time before receiving signals by the antenna to be enabled by swap step 127. In the simple-priority automatic operation mode, this waiting time is required for mechanically pointing the antenna towards the new satellite position again.

Double-priority operation mode 120 is then advantageously used if the use of one of the two services, to which double priority is allowed, cannot tolerate any significant break.

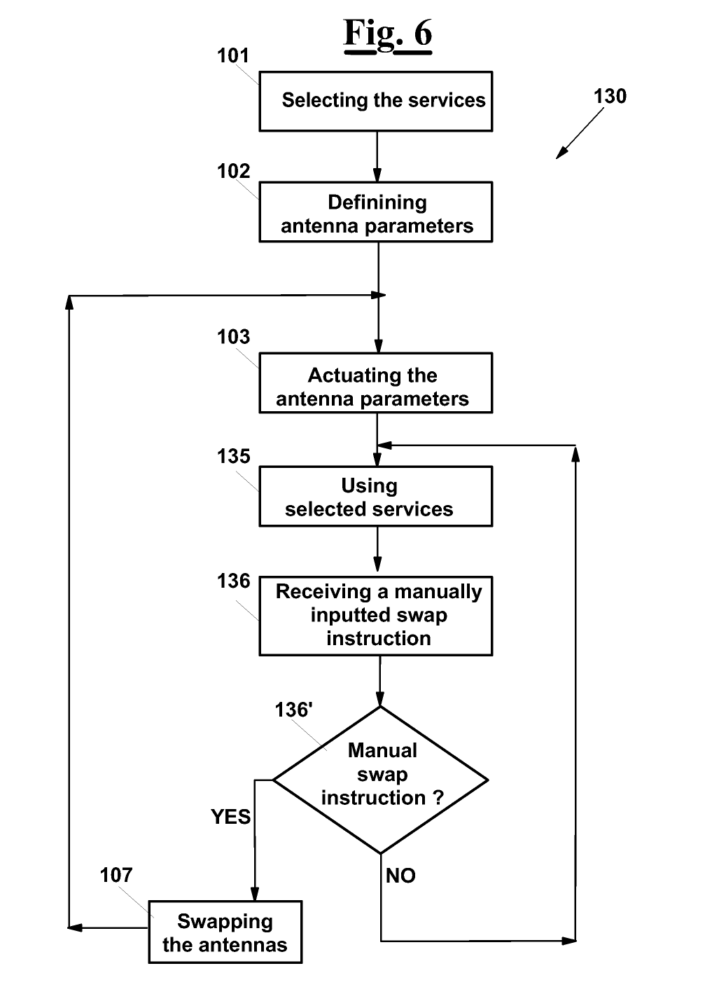

In FIG. 6 a flow diagram is shown of a manual operation mode 130 of satellite communication apparatus 200. This operation mode comprises preliminary steps 101,102,103,104 as described with reference to FIG. 3, and also comprises a step of using the services, i.e. a communication step 135 in which distribution and/or collection systems 24a and 24b are kept operatively connected with antenna 20a or with antenna 20b, as defined in association step 104, regardless the level and/or the quality of the signal received by each antenna 20a and 20b. However, a step 136 is provided of receiving a manual instruction by an operator, for actuating an antenna-swap step 137 that has a result similar to antenna-swap test 107, as described with reference to FIG. 3.

Furthermore, device 200 of FIG. 2 may advantageously comprise a manual selection device, not shown, to be used by a user for selecting an operation mode between the above described operation modes, i.e.:

a basic automatic operation mode 100;

a radio-TV-priority automatic operation mode 110;

a Internet-priority automatic operation mode 110;

a radio-TV double-priority automatic operation mode 120;

an Internet double-priority automatic operation mode 120;

a manual operation mode 130.

In the light of the above, device 200 according to the invention can ensure the use of mixed services, for example radio-TV reception and Internet communication, by using a single couple of antennas, thus limiting the cost and the size with respect to prior art TV reception and Internet communication devices for vehicles, in particular for watercrafts. Device 200 according to the invention can ensure the use of homogeneous services, for example two radio-TV reception services that are systematically available from different satellite positions, or two data exchange services provided by two different satellite positions.

Among the advantages of apparatus 200 according to the invention, there is also that of ensuring the use of both services, normally as an alternative with respect to each other, in case of failure of one of two antennas 20a,20b.

As already described, the radio-TV reception service and the Internet communication service, to which reference was made in the previous description, are given only as an example, therefore this couple of types of services may be replaced with any couple of types of services, which may comprise, besides one of those mentioned in the description, also a weather forecast service, a satellite mobile phone service, or a civil reserved data channel, for a corporate and/or military data channel, for which decoder devices are required that are not compatible to each other.

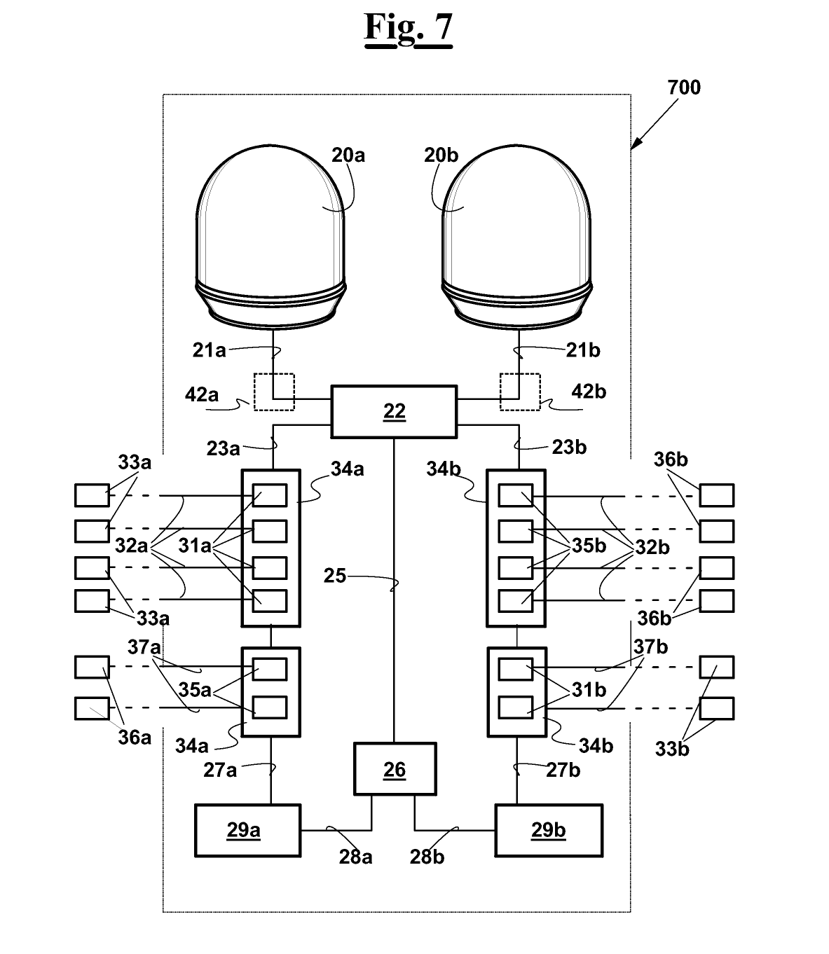

FIG. 7 diagrammatically shows a satellite communication apparatus 700 for a vehicle, for example for a watercraft, according to another exemplary embodiment of the invention. Apparatus 700 differs from apparatus 200 of FIG. 2 in that it provides multi-purpose distribution and/or collection systems 34a,34b. For example, collection and distribution system 34a comprises both distribution modules 31a for distributing a radio-TV signal to respective user-devices 33a, and data distribution and collection modules 31b for distributing input data to antennas 20a,20b and for collecting output data coming from peripheral devices 33b, whereas collection and distribution system 34a comprises both distribution modules 35b for distributing a radio-TV signal to respective user-devices 36b, and data distribution and collection modules 31b for distributing input data received by antennas 20a,20b and for receiving output data coming from peripheral device 33b. The meaning of peripheral device 33a,33b is similar to what has been indicated when describing apparatus 200 of FIG. 2, whereas peripherals 36b and 35a are qualitatively similar to peripheral 33a and 33b, respectively.

In addition to the operation modes described for apparatus 200 of FIG. 2, and shown in FIGS. 3-6, apparatus 700 allows further advantageous operation modes.

In particular, apparatus 700 allows an increased-priority Internet connection mode using two different satellites, in which data distribution and collection device 34a is operatively connected to an antenna 20a,20b that is pointed towards a first satellite by which the Internet service is provided, whereas data distribution and collection device 34b is operatively connected to the other antenna 20a,20b that is oriented towards a second satellite by which the Internet service is provided, and which is at a satellite position different from the one of the first satellite. This way, if no shielding bodies are present that shield the sight of both satellites from respective antennas 20a,20b, and if no satellite failure or maintenance conditions are present, the Internet communication takes place at a maximum traffic rate that is equal to the sum of the rate ensured by each satellite and by each antenna, i.e., it is twice the rate ensured by each antenna if the rates are the same value. If one of the two satellites pointed by antennas 20a,20b is shielded, Internet communication is ensured, even at a lower rate, even if antennas 20a,20b are swapped to ensure the use of a radio-TV service. The same condition takes place in the case of failure or of maintenance of one of the two satellites pointed by antennas 20a,20b. For instance, the two antennas may be pointed towards two different Internet satellites, and both LAN lines, by which the Internet connection is provided, form a 1 Mb connection. When both LAN lines work, a maximum traffic rate of 2 Mb is available, whereas if a LAN line is obscured, 1 Mb is available and data exchange is in any case possible, also if a satellite is out of service, the other is available still allowing 1 Mb, if a shielding body is present, antennas 20a,20b are swapped and even with one satellite working data exchange is possible.

In other words, in the above-described operation mode, device 700 ensures the continuity of the Internet communication service also in case of failure and/or of maintenance of one of the two satellites towards which antennas 20a,20b are oriented, as well as if a shielding body is present that shields one of these satellites from antennas 20a,20b.

Furthermore, in the above-described operation mode, device 700 also provides a residual possibility of using the radio-TV reception service, provided the radio-TV service is available on at least one of the two satellites towards which two antennas 20a,20b are oriented.

Similarly to what was mentioned about device 200 of FIG. 2, in the simplified representation of FIG. 7, connection means 21a/b,23a/b,37a/b of apparatus 700 comprises connection means for received RX signals, and a connection means for transmitted or TX signals.

Apparatus 700 allows also a reinforced priority operation mode of receiving a radio-TV service from two different satellites, for example, for receiving a same television programme that is broadcast by two different satellites, or for receiving a same television programme that is broadcast by channels that are provided by two different satellites. Even in this case, each distribution and collection device 34a,34b is operatively connected to one of antennas 20a,20b that is oriented towards a satellite of a predetermined couple of satellites. If one of the two satellites pointed by antennas 20a,20b is shielded, the reception of the predetermined television channel or program is ensured, also if antennas 20a,20b are swapped to ensure the use of an Internet service. The same condition occurs in case of failure or of maintenance of one of the two satellites towards which antennas 20a,20b are oriented. In other words, in the above-described operation mode, device 700 ensures the continuity of the Internet communication service also in case of failure and/or of maintenance of one of the two satellites towards which antennas 20a,20b are oriented, as well as if a shielding body is present that shields one of these satellites from antennas 20a,20b.

Furthermore, in the above-described operation mode, device 700 ensures the continuity of the reception of a television program or channel that is provided by two different satellite positions, and provides also a residual possibility of using the Internet communication service, provided the Internet service is available on at least one of the two satellites towards which two antennas 20a,20b are oriented.

Furthermore, if no shielding bodies are present that shield the sight of both satellites from respective antennas 20a,20b, and if no satellite failure or maintenance conditions are present, the above-described operation mode allows receiving two different television services that are provided by two satellites at different satellite positions.

Obviously, it is possible to provide also an apparatus, not shown, according to an exemplary embodiment of the invention, in which a distribution module is homogeneous, i.e. it is configured to distribute signals to a plurality of peripheral devices of the same type, for example all of them being TV decoder devices or all of them being personal computer/VoIP devices, and another distribution module is a multi-purpose module, i.e. it comprises distribution modules for peripheral devices of different type, for example selected among the above indicated ones.

In an advantageous exemplary embodiment, apparatus 700 has an electronic module 42a,42b for inverting the polarization of the received (RX) signals delivered by antennas 20a,20b. In FIG. 7, electronic module 42a,42b is indicated, by a dashed line, arranged on connection means 21a,21b. However, it may be arranged on connection means 23a,23b, or it may be comprised in the signal distribution and collection system 24a,24b.

Polarization inversion electronic module 42a,42b allows inverting the polarization of the signals received by antennas 20a,20b only in case of a driven mechanical polarization inversion obtained by mechanically rotating the respective feedhorns by 90°. This need occurs when antennas 20a,20b receive the data services from satellites that use opposite polarizations for transmitted signals and for received signals. This way, it is possible to mechanically rotate the respective feedhorns in accordance with the polarization of the transmitted data signal, for example a vertical polarization on a first satellite and a horizontal polarization on a second satellite, and to invert the polarization of received signals only, in order to restore the correct polarization and to enable displaying the data contained in the received radio-TV signals.

Obviously, electronic module 42a,42b for inverting the polarization of the received signals may be advantageously used in device 200 of FIG. 2.

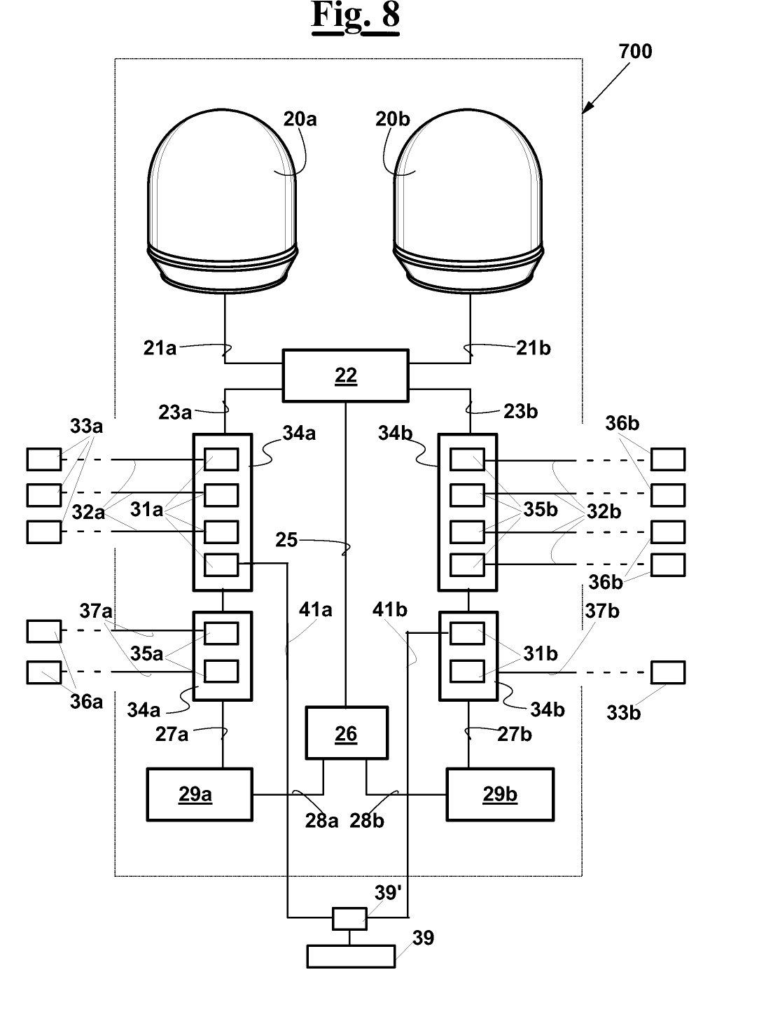

FIG. 8 shows an application of device 700 of FIG. 7, in which a radio-TV signal distribution module 41a of distribution and collection system 34a and a radio-TV signal distribution module 41b of distribution and collection system 34b are used for connecting a peripheral/user device that is a decoder device configured to receive radio-TV signals coming from two different feedhorns that, in this case, are mounted on two dishes 20a,20b. This way, through a peripheral/user device 39 it is possible to receive radio-TV signals, and therefore it is possible to display radio-TV programmes that come from two different satellite positions. Obviously, this technical solution is possible even if only one of distribution and/or collection systems 34a,34b is not provided with Internet or VoIP service distribution modules.

It is also observed that apparatuses 200,700 according to the invention, described with reference to the above figures, comply with the rules that oblige satellite communication transmitting antennas to be arranged laterally with respect to a longitudinal middle plane of a watercraft, in particular to be arranged laterally with respect to inhabited areas of the watercraft. This aims at preventing inhabited areas to be irradiated, during a transmission step, in order to minimize or to avoid any inhabitant's exposition to electromagnetic fields. These rules are already in force in some countries of the world, for instance in the USA (FCC rules).

Antennas 20a,20b have preferably a feeder as shown in FIGS. 12 and 13.

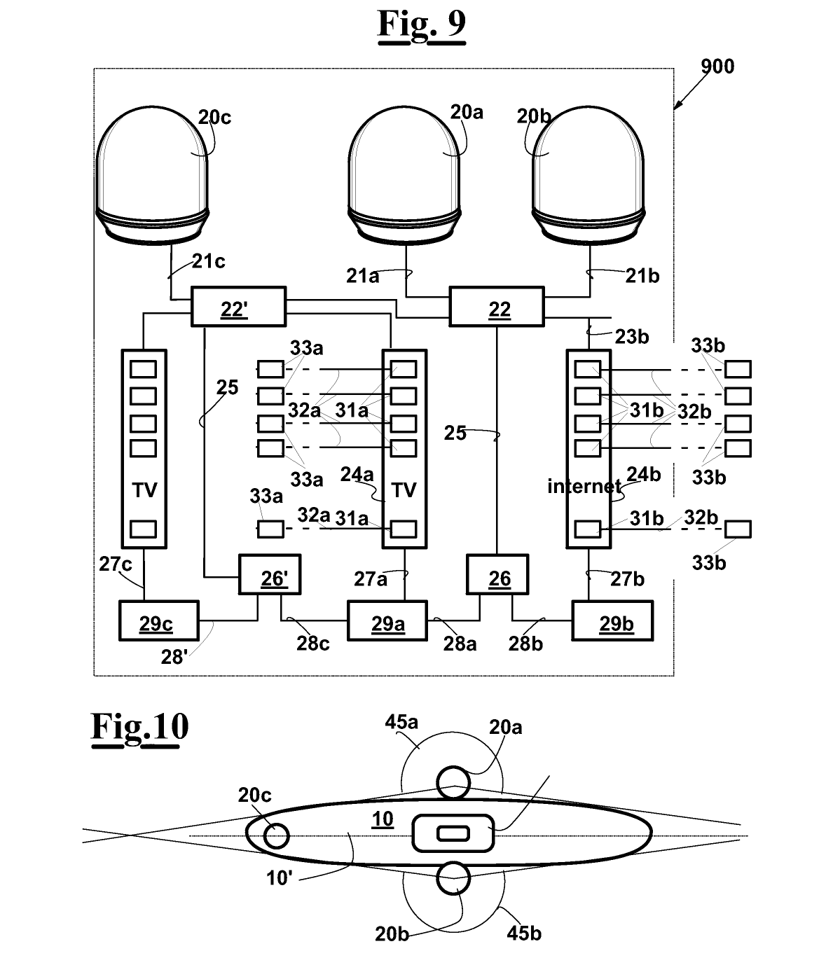

In FIG. 9 an apparatus 900 is shown according to a further exemplary embodiment of the invention, in which a third antenna 20c is present that is equipped with a control unit 29c and with a dialog unit 29′ for dialoguing with CPU 26. Moreover, dialog unit 29′ is configured to send an antenna-swap drive signal to a further switch unit 22′ that allows connecting distribution and/or collection systems 24a,24b with antenna 20c.

For example, antenna 20c may be a conventional radio-TV receiving antenna.

An advantageous arrangement of antennas 20a/b/c on a watercraft 10 is shown in FIG. 10. Antennas 20a/b have a receiving/transmission angle, with respect to longitudinal axis 10′ of the watercraft, of about 200°, in order to ensure a certain overlapping between the two angles and allow a tolerance for performing the antenna-swap when one antenna is shielded from a reference satellite by watercraft 10. If antenna 20a is engaged in an Internet communication, antenna 20b is configured to ensure a residual service, for instance, a radio television reception service. Antenna 20c allows widening the reception angle of the radio-TV service, and to ensure the use of the latter.

The system according to the invention is adapted to work both in TV-mode (DVB) and in Vsat-mode. The LNB for DVB are suitable for TV reception, and in some cases may be suitable also for Internet. However, there are Internet cases in which very high stability LNB are required such as PLL-type LNB, in this case feeder 50 of FIG. 12 can be used. Feeder 50 is suitable for both emitting and receiving, and can therefore work both in Vsat-mode, i.e. in an Internet or VoIP communication, and in an only-RX television mode.

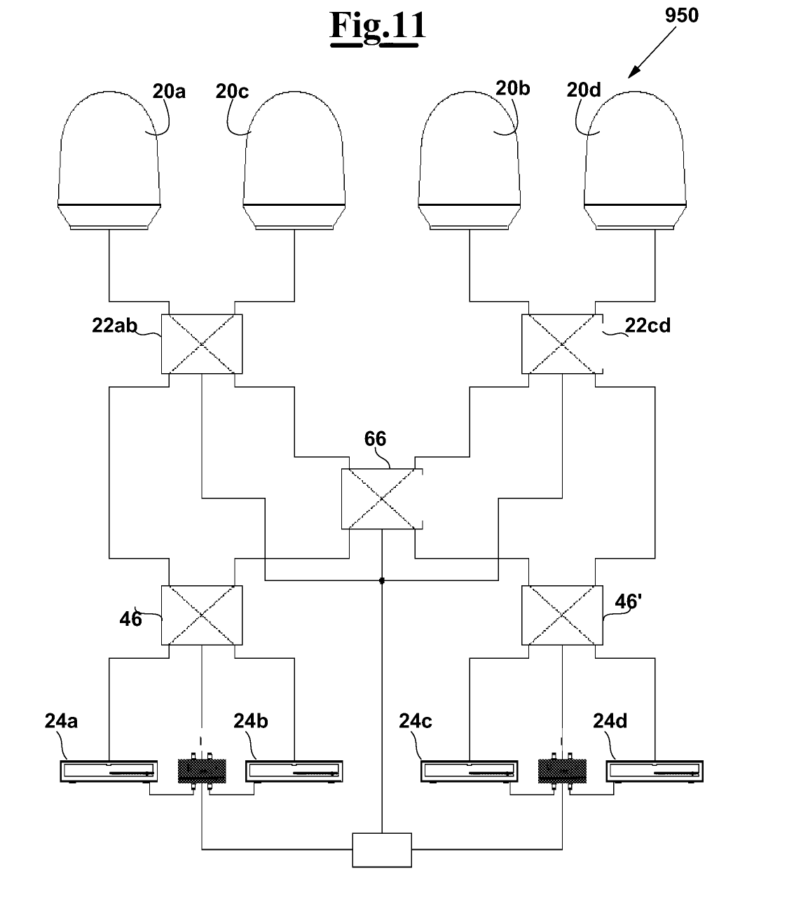

FIG. 11 shows an apparatus comprising four satellite antennas, i.e. 20a,20c on a side of watercraft 10, and 20b,20d on the opposite side, with respect to the mid-line of the watercraft. The two couples of antennas 20a/c and 20b/d, respectively, send/receive respective signals from/to switch units 22ab/22cd which in turn communicate with a network of further switch units 66,46,46′ that are configured such that distribution and/or collection systems 24a-d operate in a mode similar to the ones that have been identified as 24a/b, to receive and to distribute signals to the plurality of peripheral devices. This way, simple- and double-priority operation modes are possible, even if television and satellite signals are present at the same time, and even with two different satellites. Furthermore, with a suitable combination of direct/crossed statuses of the switch units, and with a suitable actuation sequence of the switch units, according to non-acceptability conditions of the signal, or according to lock missing conditions, which is not described in detail but can be easily understood by a skilled person who uses the teachings of the invention, it is possible to connect each distribution/collection system 24a/d with any of the antennas 20a/d.

As shown in FIG. 12, on front side of dish 20 a special so-called SOMTF element is present that is configured to separate the transmission from the reception on a polarity of the reception, on the other polarity by filtering with about 30 dB the transmission from the reception. This allows obtaining the vertical and horizontal RX on an output flange C-120 54, for all the working bands that are needed in a global configuration.

Moreover, on rear side of the dish a driven slide 61 may be present, as shown in FIG. 13, which can allow selecting one of two LNB 62 and 63, one for the Vsat system and one for the television system. The main body and a couple of connectors 64 are shown. With a LNB selected among those available on the market, it is possible to avoid the switch slide.

Moreover, the skilled person will be able to generalize the invention to the case of a number of communication satellite services higher than two, with a number of couples of antennas lower than the number of services, for example by associating apparatuses such as the apparatus 200 of FIG. 2 or as apparatus 700 of FIG. 7. This generalization, even if it is not exemplified in the drawings, falls therefore within in the field of invention.

The foregoing description of exemplary embodiments and of operation modes of the invention will so fully reveal the invention according to the conceptual point of view, so that others, by applying current knowledge, will be able to modify and/or adapt in various applications the specific exemplary embodiments without further research and without parting from the invention, and it is therefore to be understood that such adaptations and modifications will have to be considered as equivalent to the specific embodiments and of the specific operation modes. The means and the materials to realise the different functions described herein could have a different nature without, for this reason, departing from the field of the invention. It is to be understood that the expressions or the terminology that is employed herein is for the purpose of description only and, for this reason, is not for the purpose of limitation.

1. An apparatus (200) for providing an access on a vehicle (10) to a first and to a second geostationary satellites (13,14), which are available through respective first and second satellite signals that can be used by means of respective first and second peripheral devices (33a,33b), said apparatus (200) comprising:
a first and a second directional orientable antennas (20a,20b) that are configured to receive said first and said second satellite signals and to create respective received signals (21a,21b);
a first and a second distribution and/or collection systems (24a,24b) of said received signals (21a,21b), said first and said second distribution and/or collection systems (24a,24b) configured to transform a first and a second received signal (23a,23b) selected between said received signals (21a,21b) into respective user signals (32a,32b) that are intelligible by said first and by said second peripheral devices (33a,33b), respectively;
a first and a second control units (29a,29b), each of said control units (29a,29b) configured to receive said first and said second received signals (23a,23b) selected between said received signals (21a,21b), and for producing respective first and second control signals (28a,28b) that are associated with said first and with said second received signals (23a,23b);
a logical decision means (26) that is configured to receive said first and said second control signals (28a,28b) from said first and from said second signal control units (29a,29b), and that is configured to generate a switch signal (25) if at least one of said first and of said second control signals (28a,28b) does not match a predetermined admissibility condition for said respective received signal (23a,23b);
a switch unit (22) that is configured to receive said switch signal (25) and for connecting operatively each of said first and second distribution and/or collection systems (24a,24b) with said first or with said second antenna (20a,20b) according to said switch signal (25).

2. An apparatus (200) according to claim 1, wherein said first and second signal control units (29a,29b) are configured to check a lock condition of a respective antenna (20a,20b) with respect to a satellite selected between said first and said second geostationary satellites (12,14), and said first and second control signals (28a,28b) are signals of said lock condition present/missing.

3. An apparatus (200) according to claim 1, wherein said first and said second signal control units (29a,29b) are configured to evaluate the quality of said first and of said second received signals (23a,23b), respectively, and said first and said second control signals (28a,28b) are quality parameters of said first and of said second received signals (23a,23b).

4. An apparatus (200) according to claim 1, wherein at least one (24b) of said first and of said second distribution and/or collection systems comprises a collection and distribution module (31b) that is arranged to transform a signal (32′) coming from a respective peripheral device (33b) into a coded signal, and said antennas (20a,20b) are arranged to transmit said coded signal (23′) towards a geostationary satellite, in order to provide a bidirectional communication service into and from the apparatus (200).

5. An apparatus (200) according to claim 4, wherein said second distribution and/or collection system (24b) is an Internet modem, and said first distribution and/or collection module (31a) is arranged to be operatively connected to a decoder or to a radio-TV receiver.

6. An apparatus (200) according to claim 1, wherein said first and said second control units (29a,29b) are included in a first and in a second control module that is configured to receive a position and direction data of said vehicle (10) and to emit a control signal for modifying a pointing parameter of said antennas (20a,20b), responsive to said position and direction data of said vehicle (10).

7. An apparatus (200) according to claim 3, comprising a manual selection means accessible to a user for selecting an operation mode from the group consisting of:
a basic automatic operation mode (100), where said logical decision means (26) is configured to generate said switch signal (25) until none of said first and of second quality parameters (28a,28b) matches said admissibility condition;
a simple-priority automatic operation mode (110), where said logical decision means (26) is configured to generate said switch signal (25) until a single predetermined quality parameter selected between said first and said second quality parameter (28a,28b) matches said admissibility condition;
a double-priority automatic operation mode (120), wherein said switch unit (22) is adapted to operatively connect a predetermined single distribution and/or collection system selected between said first and said second distribution and/or collection systems (24a,24b) with said first or with said second antenna (20a,20b) responsive to said switch signal (25), and to cut off a non-priority distribution and/or collection system different from said predetermined single distribution and/or collection system;
a manual operation mode (130), where said switch unit (22) is configured to receive a switch signal (25) generated through a switch manual drive.

8. An apparatus (200) according to claim 1, wherein said first and said second antennas (20a,20b) comprise different waveguide reception means for a plurality of frequency bands, and said apparatus comprises a switch a means for switching said waveguide reception means.

9. An apparatus (950) according to claim 1, comprising two couples of satellite antennas (20a/c,20b/d) and a plurality of switch units (66,46,46′), wherein switch units that are associated with each couple send/receive respective signals from/to switch units (22ab/22cd) that in turn are in communication with a network of further switch units (66,46,46′) configured in such a way that distribution and/or collection systems (24a-d) receive and distribute signals to a plurality of peripheral device, in order to carry out a predetermined actuation combination/sequence of said switch units according to respective signal control signals for connecting each distribution/collection system (24a/d) with any antenna (20a/d).

10. A method for providing an access on a vehicle (10) to a first and to a second geostationary satellite, which are available through respective first and second satellite signals that can be used by means of respective first and second peripheral devices (33a,33b), said method comprising the steps of:
receiving, from a first and from a second orientable directional antennas (20a,20b), said transmitted signals, creating respective received signals (21a,21b) received by said first and by said second orientable directional antennas (20a,20b), respectively;
distributing (24a,24b) said received signals (21a,21b), and transforming (24a,24b) at least one of said received signals (21a,21b) into a first user signal or into a second user signal (32a,32b) that are intelligible by said first and by said second peripheral devices (33a,33b), respectively;
checking (29a,29b) a first and a second received signals (23a,23b) that are selected between said received signals (21a,21b) and producing respective first and second control signals (28a,28b) associated with said first and with said second reference signals (23a,23b);
processing (26,106a,106b,116,126,136′) said first and said second control signals (28a,28b), and generating a switch signal (25) if at least one of said first and of said second control signals (28a,28b) does not match a predetermined admissibility condition for said respective received signal (23a,23b);
switching, i.e. swapping antennas (22,107,127) wherein, when said switch signal (25) is generated, said first and/or said second distributed signals (32a,32b) stops being obtained transforming said at least one of said received signals (21a,21b) and starts being obtained by transforming another of said received signals (21a,21b) that is different from said at least one of said received signals (21a,21b).

11. A method according to claim 10, wherein said step of generating a switch signal (25) is carried out if only one of said control signals (28a,28b) does not match said admissibility condition, said control signals associated with a reference signal (27a,27b) of a predetermined priority service selected between said first and said second geostationary satellites.

12. A method according to claim 11, wherein, in said step of distributing, only one signal (21a,21b) related to said priority service is transformed into said distributed signal (32a,32b).

13. A method according to claim 10, wherein said first and/or said second geostationary satellite is selected among a radio-TV geostationary satellite; an Internet geostationary satellite; a weather forecast geostationary satellite; a civil reserved geostationary satellite, in particular for a corporate service; a reserved military geostationary satellite.
